(19) United States
(12) Patent Application Publication
(10) Pub. No.: US 2026/0071422 A1
(43) Pub. Date: Mar. 12, 2026

(54) DYNAMIC INSULATION SYSTEM FOR ENERGY-EFFICIENT INDOOR TEMPERATURE REGULATION

(71) Applicant: FROM THE LAND LLC, Yucaipa, CA (US)

(72) Inventors: Gina Carol Marie Oliver, Yucaipa, CA (US); Richard Stephen Hutchison, Yucaipa, CA (US)

(21) Appl. No.: 18/882,573

(22) Filed: Sep. 11, 2024

(51) Int. Cl. E04B 1/76; E06B 9/17; E06B 9/68

(52) U.S. Cl. CPC E04B 1/762; E06B 9/68; E06B 2009/17069; E06B 2009/6827

(57) ABSTRACT

An insulation system for a structure includes an insulator comprising a flexible sheet movably coupled to an exterior wall of the structure, an interior temperature sensor configured to measure an interior temperature within the structure, an exterior temperature sensor configured to measure an outside temperature of an environment surrounding the structure, a light sensor disposed outside the structure and configured to detect a sunlight intensity, and processing circuitry in communication with the interior temperature sensor, the exterior temperature sensor, and the light sensor. The insulator is movable between a deployed position in which the insulator covers a portion of the exterior wall and a retracted position in which the insulator does not cover the portion of the exterior wall. The processing circuitry is configured to actuate one or more motors to move the insulator between the deployed position and the retracted position based at least in part on the interior temperature, the outside temperature, and the sunlight intensity.

### BACKGROUND

### Field

The present disclosure generally relates to external insulation systems for building structures.

### Description of the Related Art

In various industries, such as agriculture, manufacturing, and warehousing, indoor facilities often face significant challenges related to temperature regulation. These facilities typically require extensive energy consumption to maintain optimal internal conditions, leading to high operational costs. The problem is particularly pronounced in environments where traditional insulation methods and HVAC systems are employed. These conventional systems, while effective to some extent, are inherently static and unable to adapt dynamically to fluctuating environmental conditions. Consequently, they contribute to a large energy footprint, making it imperative for industries to explore more energy-efficient solutions. The present invention addresses this critical need by introducing a dynamic insulation system that is capable of real-time adjustments in response to both internal and external environmental factors. An innovative system is needed to significantly reduces energy consumption and associated costs while maintaining the desired indoor climate, thereby offering a more sustainable and economically viable solution for various industrial applications.

### SUMMARY

In a first aspect, an insulation system for a structure includes an insulator including a flexible sheet movably coupled to an exterior wall of the structure, the insulator being movable between a deployed position in which the insulator covers a portion of the exterior wall and a retracted position in which the insulator does not cover the portion of the exterior wall; an interior temperature sensor configured to measure an interior temperature within the structure; an exterior temperature sensor configured to measure an outside temperature of an environment surrounding the structure; a light sensor disposed outside the structure and configured to detect a sunlight intensity; and processing circuitry in communication with the interior temperature sensor, the exterior temperature sensor, and the light sensor, the processing circuitry configured to actuate one or more motors to move the insulator between the deployed position and the retracted position based at least in part on the interior temperature, the outside temperature, and the sunlight intensity.

In some embodiments, the flexible sheet includes at least one of a radiant barrier, a thermally insulating material, or a shading material.

In some embodiments, the flexible sheet includes a plurality of layers including at least a thermally insulating material and at least one of a radiant barrier or a shading material.

In some embodiments, the processing circuitry stores a predetermined interior temperature range defined by a high threshold and a low threshold.

In some embodiments, the processing circuitry is configured to implement a cooling protocol when the measured interior temperature is greater than the high threshold of the interior temperature range.

In some embodiments, the cooling protocol includes positioning the insulator in the retracted position when the outside temperature is lower than the high threshold of the interior temperature range and the sunlight intensity is below a sunlight intensity threshold.

In some embodiments, the cooling protocol comprises positioning the insulator in the deployed position when the outside temperature is higher than the high threshold of the interior temperature range; or the sunlight intensity is above the sunlight intensity threshold.

In some embodiments, the processing circuitry is configured to implement a heating protocol when the measured interior temperature is lower than the low threshold of the interior temperature range.

In some embodiments, the heating protocol includes positioning the insulator in the retracted position when the outside temperature is higher than the low threshold of the interior temperature range and the sunlight intensity is above the sunlight intensity threshold.

In some embodiments, the heating protocol comprises positioning the insulator in the deployed position when the outside temperature is lower than the low threshold of the interior temperature range; or the sunlight intensity is below the sunlight intensity threshold.

In some embodiments, the insulation system further includes at least one wall temperature sensor configured to determine a temperature of the exterior wall.

In some embodiments, the processing circuitry is configured to control the position of the insulator based at least in part on the temperature of the wall while the measured interior temperature is within the interior temperature range.

In some embodiments, the processing circuitry is configured to control the position of the insulator based at least in part on the sunlight intensity while the measured interior temperature is within the interior temperature range.

In some embodiments, the exterior temperature sensor includes a plurality of individual sensors disposed at a plurality of locations outside the structure.

In some embodiments, the processing circuitry is configured to determine a calculated outside temperature based on the outside temperatures measured at the individual sensors.

In some embodiments, the interior temperature sensor includes a plurality of individual sensors disposed at a plurality of locations within the structure.

In some embodiments, the processing circuitry is configured to determine a calculated interior temperature based on the interior temperatures measured at the individual sensors.

In some embodiments, the processing circuitry is further configured to calculate a temperature gradient based on the interior temperature and the exterior temperature.

In some embodiments, the processing circuitry is further configured to control the position of the insulator based at least in part on the calculated temperature gradient.

In some embodiments, the processing circuitry is configured to actuate the one or more motors to position the insulator at one or more intermediate positions determined based at least in part on the interior temperature, the outside temperature, and the sunlight intensity.

### BRIEF DESCRIPTION OF THE DRAWINGS

FIG. 1 illustrates a side view of a wall of a building structure with an insulation system in accordance with the present technology.

FIG. 2 illustrates a front view of a wall of a building structure with an insulation system in accordance with the present technology.

FIG. 3 schematically illustrates electronic components of an insulation system in accordance with the present technology.

FIG. 4 is a flowchart illustrating an example insulation system heating logic in accordance with the present technology.

FIG. 5 is a flowchart illustrating an example cooling logic in accordance with the present technology.

### DETAILED DESCRIPTION

The present technology pertains to an advanced insulation system designed to improve temperature regulation within indoor facilities using data from environmental parameters. In various implementations, the insulation system includes a plurality of sensors located inside and outside one or more walls of the structure to monitor the interior and/or exterior temperature and/or humidity, offering real-time insights into the thermal and humidity state of the structure's interior and the surrounding environment. Data sources can further include one or more light sensors, such as photodiodes, placed to measure the intensity of sunlight striking the structure. In some embodiments, the exterior sensors can be incorporated within an outdoor weather station equipped to collect and transmit meteorological data on a wide range of environmental variables, including, but not limited to, wind speed, wind direction, rainfall, UV radiation intensity, solar radiation, barometric pressure, temperature, humidity, dew point, heat index, and wind chill. A processing unit can be in communication with the sensors and/or weather station and configured to control the position of an exterior wall insulator based on data received from the sensors and processed by the processing unit, under control of a motor that facilitates the movement and precise placement of the insulator.

The insulation unit itself is a dynamic component capable of movement in response to commands from the processing unit. In some embodiments, the insulator is designed to be either fully deployed or fully retracted, yet in other embodiments, it can also be positioned anywhere in between, depending on the thermal requirements of the facility.

In some embodiments, the insulation unit is equipped with a motorized mechanism that facilitates the smooth deployment and retraction of the insulator. This motorized system may be configured as a rotary device, allowing the insulator to rotate and cover specific portions of the facility's walls or windows as needed. In other embodiments, the insulation unit may be repositioned to cover different walls of the facility, providing flexible and targeted insulation wherever it is most needed.

The insulator can be constructed from a variety of materials which may be selected for their specific properties that contribute to the overall efficiency and durability of the system. For instance, in some embodiments, the insulator includes a radiant barrier, such as heavy-duty metalized films, which have desirable thermal reflective properties. These films can effectively reduce heat transfer, thereby enhancing the insulation's ability to maintain a stable indoor temperature. In other embodiments, the insulator may include one or more thermally insulating materials, such as insulation blanket material or the like. These materials are particularly useful in environments where exposure to the elements is a concern, as they provide both thermal protection and environmental resilience. The insulator may include a single layer or may include multiple layers of material. For example, the insulator may be a two-layer sheet including a thermally insulating layer and a thermally reflective layer such as a radiant barrier.

In some embodiments, the insulation unit is designed to operate in an autonomous manner, continuously adjusting its position based on real-time data from the sensors. The system may be capable of making these adjustments without human intervention based on continued monitoring of sensor data to maintain the desired indoor conditions. However, in some embodiments, the system may also be manually overridden, allowing a user to adjust the insulator's position according to specific operational needs or preferences. This flexibility ensures that the insulation unit can adapt to a wide range of applications and environmental conditions, providing both automated and manual control options.

In various embodiments, the system takes into account the thermal conductivity, thermal resistance, thermal mass, and thermal inertia of the building's walls and other structural elements. These properties may be integrated into the processing unit's algorithms, enabling the system to make more precise decisions about when and how to adjust the insulator. For example, buildings with high thermal mass materials, such as those constructed from cob, rammed earth, or other earthen materials, can store and release heat over time, providing a passive method of temperature regulation. The insulation unit can work in conjunction with these passive systems, enhancing their effectiveness and ensuring that the facility remains within the desired temperature range throughout the day.

The system's adaptability is further demonstrated by its ability to vary the insulation deployment based on the time of day and specific environmental conditions. In some embodiments, the insulation unit is programmed to maintain a constant interior temperature or interior temperature range, which is particularly useful in facilities where a stable climate is desired, such as in agricultural operations. In other cases, the system may be programmed to allow the interior temperature to fluctuate throughout the day, depending on factors such as sunlight exposure, outdoor temperature, and the specific needs of the facility's operations. This level of customization ensures that the insulation unit can meet the diverse requirements of different industries, providing tailored solutions for optimal energy efficiency.

Advantageously, the disclosed insulation systems may be implemented in conjunction with other active temperature control systems (e.g., HVAC systems or other temperature control systems) so as to decrease the runtime of the active temperature control systems. The power consumption of the disclosed deployable insulation systems is relatively low, for example, requiring only the amount of electrical power needed to operate a relatively low-power controller or other processing circuitry and to actuate a motor for insulation deployment and retraction. Such modest power demands are substantially lower than the amount of power required to operate a traditional HVAC system or other active temperature control. Accordingly, the use of the presently disclosed systems to reduce HVAC system runtime can result in significant reductions in cost and energy consumption to maintain a desired temperature or temperature range within a structure.

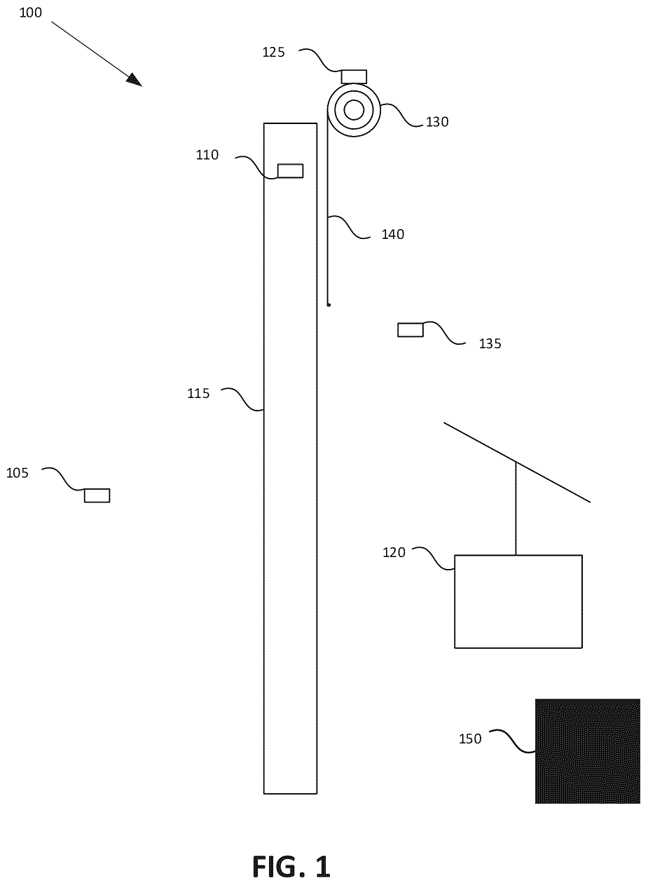

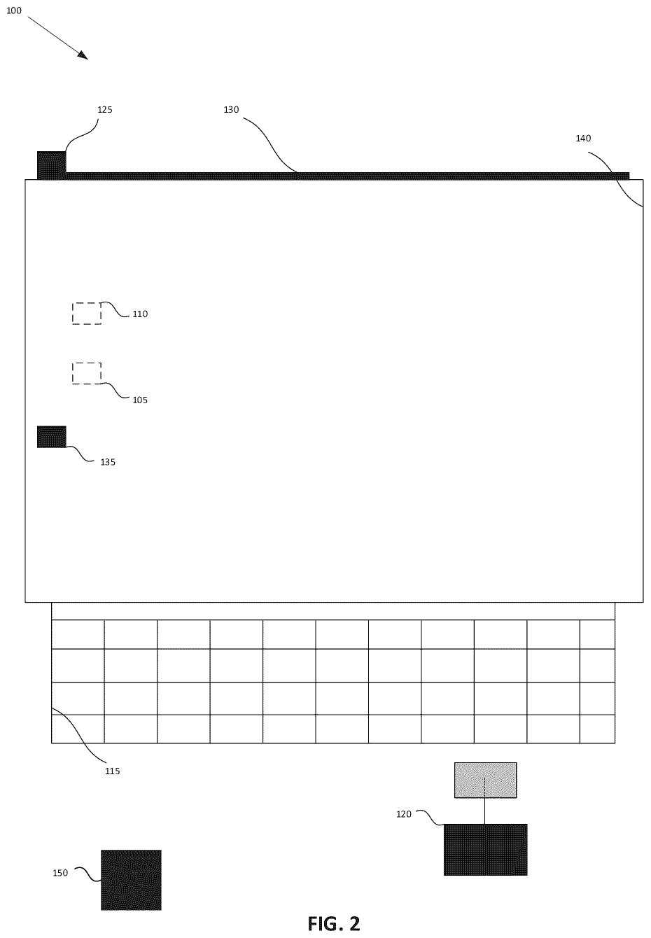

FIGS. 1 and 2 depict an example insulation system 100 installed on a structure. FIG. 1 is a side view showing a cross-section or end view of a building structure wall 115 on which the insulator 140 is mounted and disposed in a partially or fully retracted position. FIG. 2 is an elevation view of the wall 115 in which the insulator 140 is in a deployed position at least partially covering the wall 115. The insulation system 100 can include one or more interior sensors 105, one or more exterior sensors 135, one or more light sensors 125, and an insulator 140 controlled by one or more motors 130. Processing circuitry 150 is in communication with the interior sensors 105, exterior sensors 135, light sensors 125, and motors 130. The insulation system 100 may further include one or more wall sensors 110 and/or an exterior weather station 120.

Interior sensors 105, exterior sensors 135, and wall sensors 110 may each be a single sensor or a plurality of sensors, and may be configured to measure temperature, humidity, or both. The one or more light sensors 125 may be photodiode sensors or any other type of light sensor suitable for detecting the intensity of light such as sunlight incident upon the structure. The weather station 120 may include any number of sensors configured to measure one or more parameters such as, for example, wind speed, wind direction, rainfall, UV radiation intensity, solar radiation, barometric pressure, temperature, humidity, dew point, heat index, and wind chill.

The insulator 140 can include one or more layers of insulating and/or reflective material. Example materials may include, for example, a radiant barrier such as a metallic film, a thermally insulating material such as a textile material or a blanket material, and/or a shade cloth or other shading material to block light from reaching the wall 115. In some embodiments, the insulator 140 can include multiple layers of the same or different materials. In one particular non-limiting example, the insulator 140 can be a multi-layer sheet including an outer layer of shade cloth, an intermediate layer of a radiant barrier, and an inner layer of a thermal insulation material. The insulator 140 can be flexible and may be mounted on a roller controlled by the motor 130. Accordingly, the motor 130 can turn the roller in a first direction to retract the insulator 140 by winding up the insulator 140 around the roller (e.g., to the position shown in FIG. 1) and can turn the roller in a second opposite direction to deploy the insulator 140 by unwinding the insulator 140 off of the roller (e.g., to the position shown in FIG. 2). In some embodiments, a bottom end of the insulator 140 may be weighted so as to maintain the vertical positioning of the insulator 140 parallel to the wall 115 while deployed.

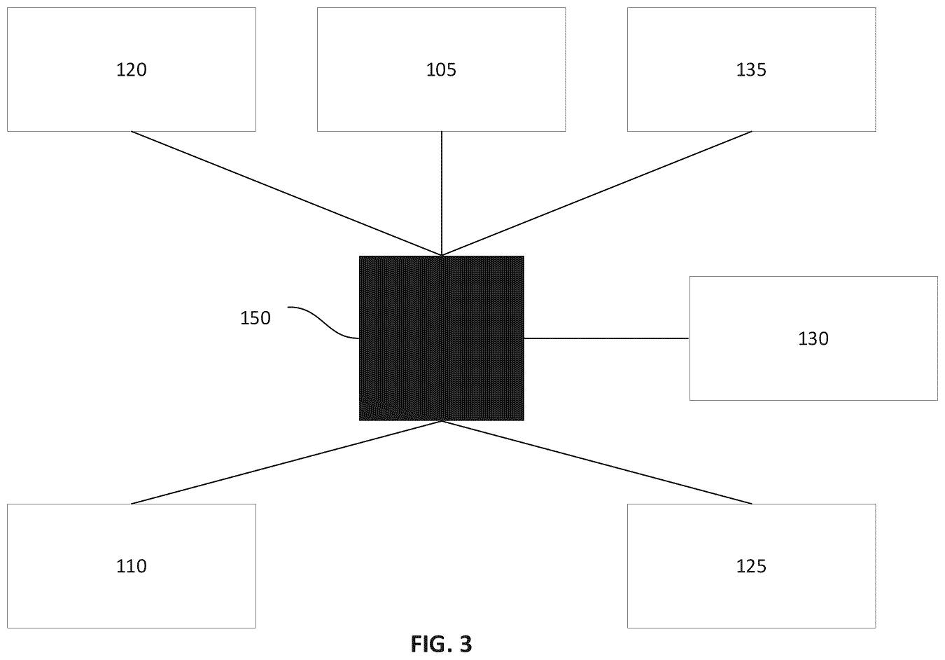

Referring now to FIG. 3, the processing circuitry 150 receives data from multiple sources, including the one or more interior sensors 105, the one or more wall sensors 110, the one or more exterior sensors 135, and the one or more light sensors 125. Additionally, the system may receive weather data from an outdoor weather station 120 if present. This weather station may be capable of monitoring a wide range of environmental variables, including wind speed, wind direction, rainfall, UV radiation, solar radiation, barometric pressure, temperature, humidity, dew point, heat index, and wind chill. The processing circuitry 150 is also in communication with the motor 130 and is configured to control actuation of the motor to extend and deploy the insulator 140 (FIGS. 1-2). The processing circuitry 150 may also receive signals from the motor 130 indicating the current position of the insulator (e.g., deployed, retracted, or at an intermediate position).

In some embodiments, the processing circuitry 150 is configured to determine a sunlight status based on signals received from the one or more light sensors 125. For example, the processing circuitry 150 may determine that a sunny condition exists when the light intensity measured at the one or more light sensors 125 exceeds a sunlight intensity threshold, and may similarly determine that a non-sunny condition exists when the light intensity measured at the one or more light sensors 125 is below the sunlight intensity threshold. Further distinctions may be made, for example, by distinguishing between a cloudy condition and a night condition, based on a second lower intensity threshold.

The processing circuitry 150 is further configured to analyze the information received from the various sensors to determine whether the insulation should be retracted or deployed to maintain the structure's interior at a desired temperature or within a desired range of temperatures. The desired temperature may vary depending on the industry that utilizes the insulation unit, and it can also change throughout the day based on the specific requirements of the operation. In the illustrated embodiment, the insulation unit has two primary positions: fully up (retracted) or fully down (deployed). However, in other embodiments, the insulation unit may be partially raised or lowered, depending on the precise temperature adjustments needed to achieve the desired indoor climate. The versatility of the system allows it to adapt to various environmental conditions and operational needs, providing a flexible and effective solution for temperature regulation.

In one example, the processing circuitry 150 is configured to maintain the temperature within the structure within a predetermined range defined by a high threshold and a low threshold. The processing circuitry 150 can periodically receive temperature data from the one or more interior sensors 105 to monitor the temperature within the structure. If the one or more interior sensors includes multiple sensors at different locations within the interior, the processing circuitry 150 can determine a calculated interior temperature based on the individual temperature readings, such as by calculating an average, a weighted average, or any other suitable mathematical or statistical measure based on the individual temperature readings. The processing circuitry 150 may similarly determine a calculated outside temperature if there are multiple exterior sensors 135.

If the interior temperature or calculated interior temperature exceeds the high threshold or other stored setpoint temperature, the processing circuitry 150 may responsively implement a cooling protocol, in accordance with cooling logic stored in a memory of the processing circuitry 150. Similarly, if the interior temperature or calculated interior temperature decreases below the low threshold or other stored setpoint temperature, the processing circuitry 150 may responsively implement a heating protocol, in accordance with heating logic stored in a memory of the processing circuitry 150.

The processing circuitry 150 may further be configured to control retraction or deployment of the insulation while the temperature is within the desired temperature range, for example, based on the current sunlight status, wall temperature, or a calculated temperature gradient across the wall. For example, if the interior temperature is still within the range but is determined to be increasing and the processing circuitry 150 determines that a sunny condition exists, the insulator 140 may be deployed so as to block and/or reflect sunlight to prevent solar radiation from further heating the interior through the wall 115. In another example, if the interior temperature is acceptable but the wall temperature is relatively high and the exterior temperature is low, the insulator 140 may be deployed so that heat from the wall dissipates to the interior more than to the exterior environment.

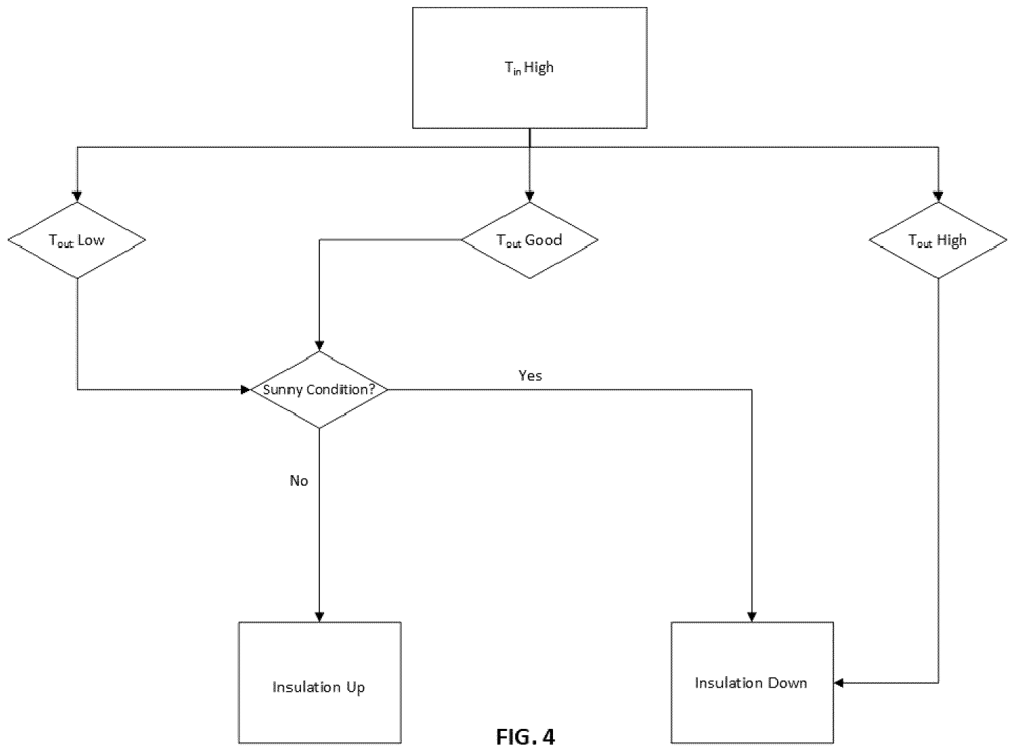

FIG. 4 illustrates an example embodiment of a cooling logic used by the processing circuitry 150 to facilitate cooling of the interior of the structure. The cooling logic may be embodied in computer-executable instructions stored in a non-transitory computer-readable memory of the processing circuitry 150 that, when executed, cause one or more processors of the processing circuitry 150 to execute the following logical operations. The cooling logic of FIG. 4 will be described with reference to certain components of FIGS. 1-3, but can similarly be implemented with any other deployable insulation system. Moreover, the cooling logic of FIG. 4 need not be a standalone process; the cooling logic in some embodiments may be implemented in conjunction with one or more other cooling processes, such as activation of a separate active cooling or air conditioning system, an active ventilation system, or the like.

The example cooling logic can be initiated when the processing circuitry 150 determines that the interior temperature is higher than desired, for example, if the measured or calculated interior temperature increases beyond the high threshold of a predetermined stored temperature range or another relevant temperature setpoint. In the example cooling logic, once the high temperature is detected, the processing circuitry 150 then determines whether the exterior temperature of the environment surrounding the structure is low, good, or high. In various embodiments, the determination of low, good, or high with regard to the exterior temperature can be made using the same high and low thresholds defining the desired interior temperature range, or may use a separately stored exterior temperature range that may have a low and/or high threshold that differs from the corresponding interior temperature threshold.

If the exterior temperature is determined to be high (e.g., greater than the high threshold of the desired interior temperature range or greater than another stored high threshold), the processing circuitry 150 can actuate the motor 130 to deploy the insulator 140 if it is not already deployed, regardless of the current sunlight condition, so as to prevent further heating from outside. If the exterior temperature is determined to be low or good (e.g., lower than the high threshold of the desired interior temperature range or lower than another stored high threshold), the processing circuitry 150 then determines the current sunlight condition. If the light intensity measured at the light sensor 125 is below a sunlight intensity threshold (e.g., indicating a cloudy and/or night condition), the processing circuitry 150 can actuate the motor 130 to retract the insulator 140, such that the structure and the wall 115 can transfer heat out into the environment by radiation and/or thermal conduction. If the light intensity measured at the light sensor 125 is above a sunlight intensity threshold (e.g., indicating a sunny condition), the processing circuitry 150 can actuate the motor 130 to deploy the insulator 140.

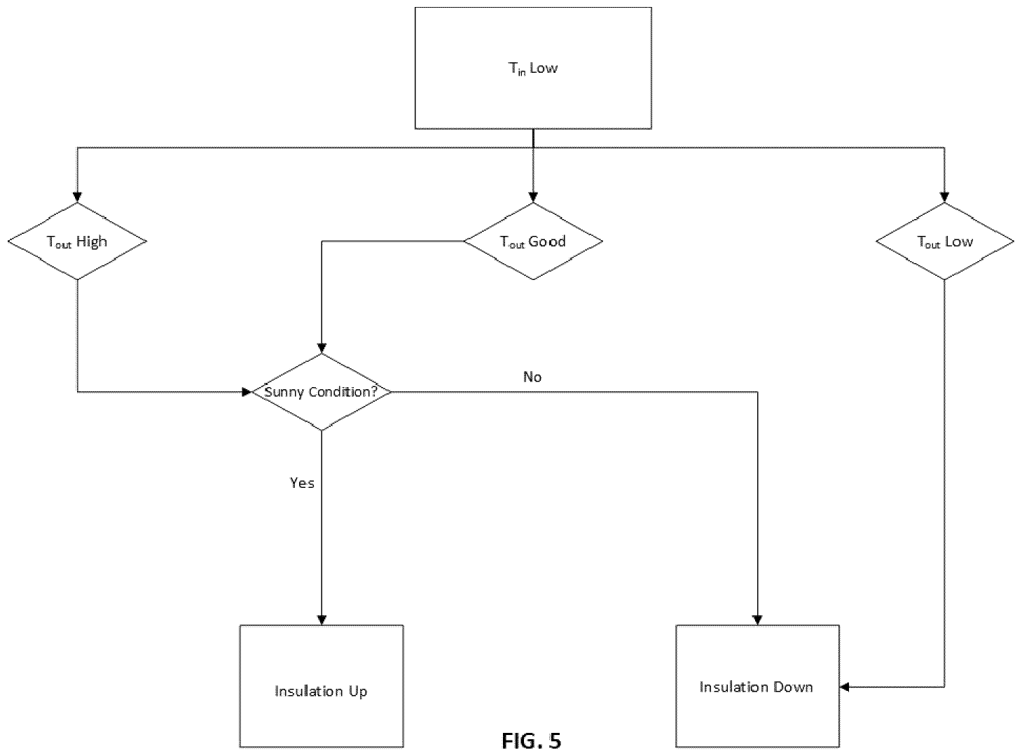

FIG. 5 illustrates an example embodiment of a heating logic used by the processing circuitry 150 to facilitate heating of the interior of the structure. The heating logic may be embodied in computer-executable instructions stored in a non-transitory computer-readable memory of the processing circuitry 150 that, when executed, cause one or more processors of the processing circuitry 150 to execute the following logical operations. The heating logic of FIG. 5 will be described with reference to certain components of FIGS. 1-3, but can similarly be implemented with any other deployable insulation system. Moreover, the heating logic of FIG. 5 need not be a standalone process; the heating logic in some embodiments may be implemented in conjunction with one or more other heating processes, such as activation of a separate active heating or air conditioning system, an active ventilation system, or the like.

The example heating logic can be initiated when the processing circuitry 150 determines that the interior temperature is lower than desired, for example, if the measured or calculated interior temperature decreases below the low threshold of a predetermined stored temperature range or another relevant temperature setpoint. In the example heating logic, once the low temperature is detected, the processing circuitry 150 then determines whether the exterior temperature of the environment surrounding the structure is low, good, or high. In various embodiments, the determination of low, good, or high with regard to the exterior temperature can be made using the same high and low thresholds defining the desired interior temperature range, or may use a separately stored exterior temperature range that may have a low and/or high threshold that differs from the corresponding interior temperature threshold.

If the exterior temperature is determined to be low (e.g., lower than the low threshold of the desired interior temperature range or lower than another stored low threshold), the processing circuitry 150 can actuate the motor 130 to deploy the insulator 140 if it is not already deployed, regardless of the current sunlight condition, so as to retain the remaining heat within the structure rather than losing more heat to the outside. If the exterior temperature is determined to be low or good (e.g., higher than the low threshold of the desired interior temperature range or higher than another stored low threshold), the processing circuitry 150 then determines the current sunlight condition. If the light intensity measured at the light sensor 125 is above a sunlight intensity threshold (e.g., indicating a sunny condition), the processing circuitry 150 can actuate the motor 130 to retract the insulator 140, so as to gain additional heat by absorption of solar radiation through the wall 115. If the light intensity measured at the light sensor 125 is below a sunlight intensity threshold (e.g., indicating a cloudy and/or night condition), the processing circuitry 150 can actuate the motor 130 to deploy the insulator 140.

The insulation systems described in this application represents a significant advancement in the field of temperature regulation for facilities such as industrial, commercial, residential, or other facilities. The unit's ability to adapt dynamically to changing environmental conditions makes it a powerful tool for reducing energy consumption and associated costs. By integrating a comprehensive array of sensors, a sophisticated data processing unit, and a flexible insulator, the system offers a level of precision and efficiency that is unmatched by traditional insulation methods.

The present insulation systems can be configured to operate autonomously, making real-time adjustments based on data from the sensors and weather station. This autonomy allows the system to respond to changes in temperature, sunlight intensity, and weather conditions without requiring human intervention. However, the system is also designed to accommodate manual overrides, giving users the flexibility to adjust the insulation settings according to specific operational needs or preferences. This dual mode of operation ensures that the insulation unit can be tailored to a wide range of applications and environments, providing both automated and user-controlled options for optimal performance.

The materials used in the construction of the insulator are carefully selected to enhance the system's thermal efficiency and durability. In some embodiments, the insulator is made from heavy-duty metalized films, which are known for their excellent reflective properties. These films are capable of reducing heat transfer by reflecting infrared radiation, thereby keeping the interior of the facility cooler in hot weather. In other embodiments, the insulator may be composed of insulation blankets that offer additional benefits such as waterproofing and noise reduction. These materials are particularly useful in environments where exposure to moisture or noise is a concern, providing both thermal protection and environmental resilience.

The system's adaptability is further demonstrated by its ability to integrate the thermal properties of the building materials into its decision-making process. Buildings with high thermal mass, such as those constructed from cob, rammed earth, or other earthen materials, can store and release heat over time, providing a passive method of temperature regulation. The insulation unit can work in conjunction with these passive systems, enhancing their effectiveness and ensuring that the facility remains within the desired temperature range throughout the day. By taking into account the thermal conductivity, thermal resistance, thermal mass, and thermal inertia of the building materials, the system can make more informed decisions about when and how to deploy the insulator for maximum energy efficiency.

In addition to its use in industrial facilities, the insulation unit is particularly well-suited for agricultural applications. In environments where maintaining a stable climate is critical for crop growth or livestock welfare, the system's ability to maintain a constant interior temperature or to vary the temperature according to specific schedules is invaluable. The insulation unit can be programmed to adjust the interior temperature based on factors such as sunlight exposure, outdoor temperature, and the specific needs of the agricultural operation. This level of customization ensures that the system can meet the diverse requirements of different industries, providing tailored solutions for optimal energy efficiency.

The dynamic insulation system described in this patent application offers a comprehensive and flexible solution for temperature regulation in a wide range settings. By combining advanced sensor technology, sophisticated data processing, and durable insulating materials, the system provides a powerful tool for reducing energy consumption, lowering operational costs, and improving sustainability. The ability to operate autonomously or under manual control, coupled with the system's adaptability to different building materials and environmental conditions, makes it a versatile and effective solution for modern temperature regulation challenges.

### Additional Embodiments

It will be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

Many other variations than those described herein will be apparent from this disclosure. For example, depending on the embodiment, certain acts, events, or functions of any of the algorithms described herein can be performed in a different sequence, can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal.

All of the methods and processes described herein may be embodied in, and partially or fully automated via, software code modules executed by one or more general purpose computers. For example, the methods described herein may be performed by the computing system and/or any other suitable computing device. The methods may be executed on the computing devices in response to execution of software instructions or other executable code read from a tangible computer readable medium. A tangible computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

What is claimed is:

1. An insulation system for a structure, the insulation system comprising:
an insulator comprising a flexible sheet movably coupled to an exterior wall of the structure, the insulator being movable between a deployed position in which the insulator covers a portion of the exterior wall and a retracted position in which the insulator does not cover the portion of the exterior wall;
an interior temperature sensor configured to measure an interior temperature within the structure;
an exterior temperature sensor configured to measure an outside temperature of an environment surrounding the structure;
a light sensor disposed outside the structure and configured to detect a sunlight intensity; and
processing circuitry in communication with the interior temperature sensor, the exterior temperature sensor, and the light sensor, the processing circuitry configured to actuate one or more motors to move the insulator between the deployed position and the retracted position based at least in part on the interior temperature, the outside temperature, and the sunlight intensity.

2. The insulation system of claim 1, wherein the flexible sheet comprises at least one of a radiant barrier, a thermally insulating material, or a shading material.

3. The insulation system of claim 2, wherein the flexible sheet comprises a plurality of layers including at least a thermally insulating material and at least one of a radiant barrier or a shading material.

4. The insulation system of claim 1, wherein the processing circuitry stores a predetermined interior temperature range defined by a high threshold and a low threshold.

5. The insulation system of claim 4, wherein the processing circuitry is configured to implement a cooling protocol when the measured interior temperature is greater than the high threshold of the interior temperature range.

6. The insulation system of claim 5, wherein the cooling protocol comprises positioning the insulator in the retracted position when the outside temperature is lower than the high threshold of the interior temperature range and the sunlight intensity is below a sunlight intensity threshold.

7. The insulation system of claim 5, wherein the cooling protocol comprises positioning the insulator in the deployed position when:
the outside temperature is higher than the high threshold of the interior temperature range; or
the sunlight intensity is above the sunlight intensity threshold.

8. The insulation system of claim 4, wherein the processing circuitry is configured to implement a heating protocol when the measured interior temperature is lower than the low threshold of the interior temperature range.

9. The insulation system of claim 8, wherein the heating protocol comprises positioning the insulator in the retracted position when the outside temperature is higher than the low threshold of the interior temperature range and the sunlight intensity is above the sunlight intensity threshold.

10. The insulation system of claim 8, wherein the heating protocol comprises positioning the insulator in the deployed position when:
the outside temperature is lower than the low threshold of the interior temperature range; or
the sunlight intensity is below the sunlight intensity threshold.

11. The insulation system of claim 4, further comprising at least one wall temperature sensor configured to determine a temperature of the exterior wall.

12. The insulation system of claim 11, wherein the processing circuitry is configured to control the position of the insulator based at least in part on the temperature of the wall while the measured interior temperature is within the interior temperature range.

13. The insulation system of claim 4, wherein the processing circuitry is configured to control the position of the insulator based at least in part on the sunlight intensity while the measured interior temperature is within the interior temperature range.

14. The insulation system of claim 1, wherein the exterior temperature sensor comprises a plurality of individual sensors disposed at a plurality of locations outside the structure.

15. The insulation system of claim 14, wherein the processing circuitry is configured to determine a calculated outside temperature based on the outside temperatures measured at the individual sensors.

16. The insulation system of claim 1, wherein the interior temperature sensor comprises a plurality of individual sensors disposed at a plurality of locations within the structure.

17. The insulation system of claim 16, wherein the processing circuitry is configured to determine a calculated interior temperature based on the interior temperatures measured at the individual sensors.

18. The insulation system of claim 1, wherein the processing circuitry is further configured to calculate a temperature gradient based on the interior temperature and the exterior temperature.

19. The insulation system of claim 18, wherein the processing circuitry is further configured to control the position of the insulator based at least in part on the calculated temperature gradient.

20. The insulation system of claim 1, wherein the processing circuitry is configured to actuate the one or more motors to position the insulator at one or more intermediate positions determined based at least in part on the interior temperature, the outside temperature, and the sunlight intensity.
